(19) United States
(12) Patent Application Publication
(10) Pub. No.: US 2026/0194113 A1
(43) Pub. Date: Jul. 9, 2026

(54) ENGAGEMENT SPEED CONTROLLED CLUTCH

(71) Applicant: GKN Automotive Limited, Birmingham (GB)

(72) Inventors: Akira Ibusuki, Bonn (DE); Mark Schmidt, Königswinter (DE)

(21) Appl. No.: 19/421,352

(22) Filed: Dec. 16, 2025

Related U.S. Application Data
(60) Provisional application No. 63/743,320, filed on Jan. 9, 2025.

(51) Int. Cl. F16D 11/14; B60K 17/02; F16H 48/08; F16H 48/24

(52) U.S. Cl. CPC F16D 11/14; B60K 17/02; F16H 48/08; F16H 48/24

(57) ABSTRACT

A dog clutch includes a first clutch member and a second clutch member. The first clutch member is rotatable about an axis and has first teeth circumferentially spaced apart. Each tooth has a first face and a second face with different axial length. The second clutch member is rotatable about the axis relative to the first clutch member and has second teeth each having a first face and a second face of different axial length. An axially longer face of the first teeth is adjacent to an axially longer face of the second teeth when the first clutch member and the second clutch member are in an engaged state in which the first teeth are received in the second pockets, and the second teeth are received in the first pockets. The dog clutch may be provided in a differential of a vehicle.

### REFERENCE TO RELATED APPLICATIONS

This application claims the benefit of U.S. Provisional Application Serial No. 63/743,320 filed on January 9, 2025 the content of which is incorporated herein by reference in its entirety.

### TECHNICAL FIELD

The present disclosure relates generally to a dog clutch, such as may be used in a differential to provide a disconnect or locking function.

### BACKGROUND

Dog clutches have teeth that become meshed to transfer torque through the clutch. Clutch designs with conventional teeth shapes lead to clutch engagement at high rotational speeds which can introduce higher impact forces to the torque distribution parts of a vehicle driveline. The higher impact and resulting forces can damage components and/or require larger, heavier and stronger components to manage the forces.

### SUMMARY

In at least some implementations, a dog clutch includes a first clutch member and a second clutch member. The first clutch member has a first body rotatable about an axis of rotation and first teeth extending axially from the first body. The first teeth are circumferentially spaced apart with first pockets defined between adjacent ones of the first teeth, each tooth of the first teeth having a first face and a second face, and an axial length of the first face is different than the axial length of the second face. The second clutch member has a second body rotatable about the axis of rotation and movable axially relative to the first clutch member. The second clutch member has second teeth extending axially from the second body, the second teeth are circumferentially spaced apart with second pockets defined between adjacent ones of the second teeth, each tooth of the second teeth having a first face and a second face, and an axial length of the first face is different than the axial length of the second face. An axially longer face of the first teeth is adjacent to an axially longer face of the second teeth when the first clutch member and the second clutch member are in an engaged state in which the first teeth are received in the second pockets, and the second teeth are received in the first pockets.

In at least some implementations, each tooth of the first teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body. In at least some implementations, the axial dimension of the inclined surface is between 15% and 30% of the length of the tooth from the tip to the body. In at least some implementations, the axial length of the second face is greater than the axial length of the first face not including the axial dimension of the inclined surface. In at least some implementations, the axial length of the first face not including the axial dimension of the inclined surface is at least 0.3mm less than the axial length of the second face. In at least some implementations, the second face has a rounded or chamfered surface leading to the tip, and the axial length of the first face not including the axial dimension of the inclined surface is at least 0.3mm less than the axial length of the second face not including the axial dimension of the rounded or chamfered surface of the second face.

In at least some implementations, each tooth of the second teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body. In at least some implementations, the axial dimension of the inclined surface is between 15% and 30% of the length of the tooth from the tip to the body. In at least some implementations, the axial length of the second face is greater than the axial length of the first face not including the axial dimension of the inclined surface. In at least some implementations, the second face has a rounded or chamfered surface leading to the tip, and the axial length of the first face not including the axial dimension of the inclined surface is at least 0.3mm less than the axial length of the second face not including the axial dimension of the rounded or chamfered surface of the second face.

In at least some implementations, a differential includes a first housing arranged to be rotated by a vehicle motive power source, a second housing, differential gears coupled to the second housing, and a clutch. The differential gears include at least one pinion gear, a first side gear engaged with the pinion gear, and a second side gear engaged with the pinion gear. The clutch has a first clutch member that is coupled to the second housing and a second clutch member that is coupled to the first housing, the clutch has a disengaged state in which the first housing rotates relative to the second housing, and the clutch has an engaged state in which the second housing is coupled to and rotates with the first housing. The first clutch member has a first body rotatable about an axis of rotation and first teeth extending axially from the first body, the first teeth are circumferentially spaced apart with first pockets defined between adjacent ones of the first teeth, each tooth of the first teeth having a first face and a second face and an axial length of the first face is different than the axial length of the second face. The second clutch member having a second body rotatable about the axis of rotation and movable axially relative to the first clutch member, the second clutch member has second teeth extending axially from the second body, the second teeth are circumferentially spaced apart with second pockets defined between adjacent ones of the second teeth, each tooth of the second teeth having a first face and a second face, and an axial length of the first face is different than the axial length of the second face. An axially longer face of the first teeth is adjacent to an axially longer face of the second teeth when the first clutch member and the second clutch member are in an engaged state in which the first teeth are received in the second pockets, and the second teeth are received in the first pockets.

In at least some implementations, an axially shorter face of the first teeth is a leading face when a vehicle including the differential is traveling in a reverse direction.

### BRIEF DESCRIPTION OF THE DRAWINGS

The following detailed description of preferred implementations and best mode will be set forth with regard to the accompanying drawings, in which:

FIG. 1 is a cross-sectional view of a portion of a differential with an electrically actuated clutch shown in a disengaged position;

FIG. 2 is a cross-sectional view of a portion of the differential with the clutch shown in an engaged position;

FIG. 3 is an enlarged diagrammatic view showing first and second clutch members of the clutch shown in a position during actuation of the clutch from the disengaged to the engaged position;

FIG. 4 is a view similar to FIG. 3 and showing a tooth of a second clutch member nearly aligned with a pocket between adjacent teeth of a first clutch member;

FIG. 5 is a view similar to FIG. 4 and showing a failure of the second clutch member to engage the first clutch member due to relative speed of rotation between the clutch members above a threshold;

FIG. 6 is a view similar to FIG. 4 and showing initial engagement of the second clutch member with the first clutch member when the relative speed of rotation between the clutch members is within the threshold;

FIG. 7 is a view of the clutch members showing a tooth of the second clutch member in driving engagement with a tooth of the first clutch member;

FIG. 8 is a view of first and second clutch members having differently shaped teeth;

FIG. 9 is a diagrammatic view showing tips of diametrically opposed teeth of the second clutch member of FIG. 8; and

FIG. 10 is a perspective view of a portion of a clutch member

### DETAILED DESCRIPTION

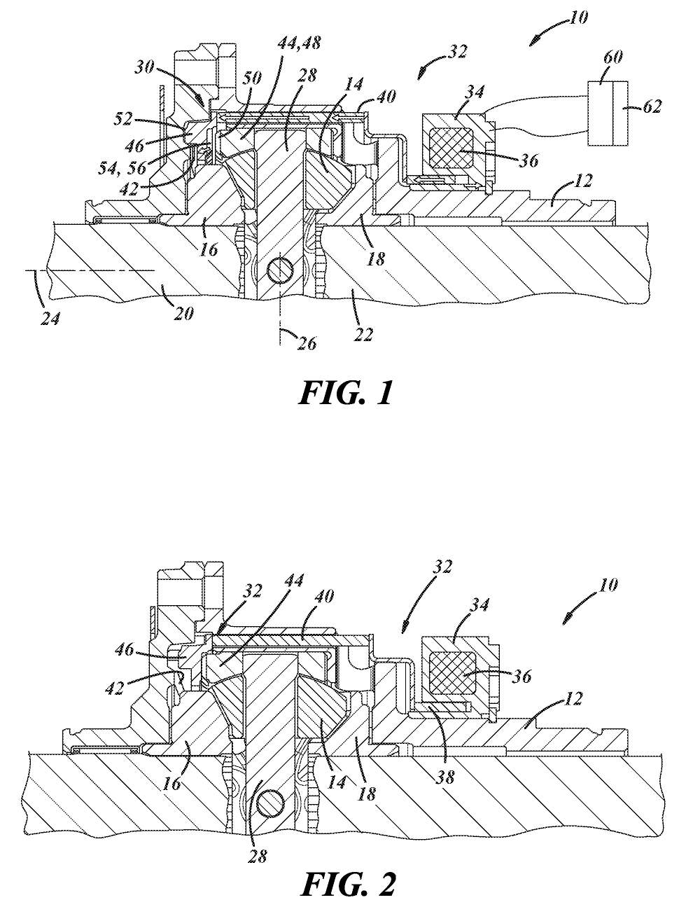

Referring in more detail to the drawings, FIGS. 1 and 2 illustrate a portion of a differential 10 having an outer housing 12 (which in this example is formed by two parts 12a, 12b, labeled in FIG. 1), two or more pinion gears 14 (only one shown in FIGS. 1 and 2), and a pair of side gears 16, 18 that are arranged to be coupled to rotating shafts 20, 22 that may drive, for example, wheels of a vehicle. Thus, the side gears 16, 18 rotate with the shafts 20, 22 (shown diagrammatically in FIG. 1) about a shaft axis 24 and the pinion gears 14 are rotatable about an axis 26 defined by a pinion gear shaft 28 extending through the pinion gears.

The differential 10 also includes a clutch assembly 30 that, in this example, is driven by an electromagnetic actuator 32 having a solenoid 34 with an annular wire coil 36 and a drive member that may include an armature or plunger 38 that is received at least partially radially inwardly of and axially overlapped with the coil 36. In at least some implementations, the plunger 38 is also annular, the plunger and coil 36 are coaxially arranged about axis 24 and are carried by the outer housing 12 of the differential 10 for rotation with the outer housing 12. One shaft 22 extends coaxially through a portion of the housing 12 that extends through the coil 36 and plunger 38. Electric power is supplied to the coil 36 to generate a magnetic field that displaces the plunger 38 relative to the coil 36 and outer housing 12 from a first or advanced position (FIG. 2) to a second or retracted position (FIG. 1). The plunger 38 may be formed from multiple materials including a material that is magnetically responsive to the magnetic field generated by the coil 36, and one or more other materials that may or might not be responsive to the magnetic field. Thus, when the magnetic field is generated by the coil 36, the plunger 38 may be driven from one position to another (e.g. from the advanced position to the retracted position as shown in FIGS. 2 and 1, respectively). As used herein, a material is responsive to a magnetic field if a magnetic field of the magnitude generated by a solenoid 34 of the type used in applications such as that described herein, may cause a component formed of or including such material to move.

To facilitate return of the plunger 38 from the second position back to the first position when power is not provided to the coil 36, a biasing member, such as a spring 42 may act on the plunger 38, or on a component engaged with the plunger, such as part of the clutch 30 to which the plunger is coupled, as set forth below. In at least some implementations, the clutch assembly 30 is disengaged when the plunger 38 is in the first position, as shown in FIG. 1, and the clutch assembly 30 is engaged when the plunger 38 is in the second position, as shown in FIG. 2. While in the example shown the plunger 38 is in its first position when power is provided to the coil 36 and the plunger 38 moves to the second position when power is not supplied to the coil 36, the opposite could be true if desired (e.g. the clutch assembly 30 could be moved to the disengaged position by the biasing member 42 and be engaged by powering the coil 36). Actuators other than a solenoid-type electromagnetic actuator may be used to drive the clutch, such as but not limited to, a motor (e.g. that drives a cam arrangement, or a ball screw arrangement, etc), or a hydraulic or pneumatic actuator, or other rotary to linear actuators or linear actuators.

In at least some implementations, the clutch assembly 30 is an engaging clutch such as a dog clutch, and includes a first clutch member 44 that is not movable in an axial direction (defined by the central axis 24 of the plunger), and a second clutch member 46 that is movable in the axial direction relative to the first member 44. In the example shown, the solenoid 34 and plunger 38 are on one side of the housing 12 and the second clutch member is on an opposite side of the housing and is coupled to the plunger by a rod 40. In at least some implementations, the clutch assembly 30 may be used, for example, in a disconnect mechanism of the differential 10 that selectively interrupts and permits torque transmission therethrough. In this device, a first rotating body is the outer differential housing 12 and a second rotating body is an inner housing 48, and the first rotating body and the second rotating body rotate about a common rotational axis 24. The inner housing 48 may define the first clutch member and include clutch teeth formed directly and integrally in a body that defines the inner housing 48. Or, as in the implementation shown, the inner housing 48 is connected to the first clutch member 44 that includes the clutch teeth 50 and so the first clutch member 44 is constrained against axial movement relative to the second clutch member 46.

Referring to FIG. 2, the second clutch member 46 may be coaxial with the axis 24 of the plunger 38, and may be received outboard of the pinion gear 14 (i.e. farther from the axis 24 than the pinion gear 14). The second clutch member 46 may include a rear face 52 and a front face 54 having at least one engagement feature, such as gear or clutch teeth 56 (e.g. dog clutch teeth) configured to engage a corresponding engagement feature (e.g. the clutch teeth 50) formed on the first clutch member 44. The second clutch member 46 rotates together with, and may be connected by a spline feature to, the housing 12. The second clutch member 46 can freely move in the axial direction relative to the housing 12 as the spline allows sliding motion. The spline may have a tapered angle to apply more position flexibility and reactive thrust by the torque to the clutch member 46.

In at least some implementations, the spring 42 may be located between an inner surface of the outer housing 12 and the second clutch member 46 to yieldably bias the second clutch member 46 to the advanced position in which the second clutch member teeth 56 are meshed with the first clutch member teeth 50. The spring 42 may be located radially inwardly or radially outwardly of the second clutch member 46, or both (e.g. more than one spring may be provided). Like the coil 36 and plunger 38, the second clutch member 46 also is carried by and rotates with the outer housing 12.

In FIG. 1, the differential 10 is shown with the clutch 30 in a disengaged position. In the illustrated implementation, in the disengaged position of the clutch 30, the coil 36 is powered, the plunger 38 is in its first position (i.e. advanced position) and the second clutch member 46 is not engaged with the first clutch member 44 (that is, second clutch member teeth 56 are not meshed with the first clutch member teeth 50). In the disconnected position, the shafts/axles 20, 22 are not actively driven and may rotate relative to the second clutch member 46 and outer housing 12.

To change the clutch 30 from the disengaged position to the engaged position, shown in FIG. 2, the coil 36 is not powered and the spring 42 drives the plunger 38 to its second position (i.e. retracted position) which drives the second clutch member 46 into engagement with the first clutch member (i.e. teeth 56 engage and mesh with teeth 50). In this position, the inner housing 48 is coupled to and rotates with the outer housing 12 and torque is transmitted to the axles 20, 22, while the differential pinion shaft 28 is supported with the inner housing 48 and the second clutch member 46 is connected to the outer housing 12 in rotational direction with axially formed sliding splines.

To control actuation of the actuator 32, the coil 36 may be communicated with a processor 60 or controller (FIG. 1), and the processor 60 may selectively accesses memory 60 and/or other computer-readable medium that includes instructions executable by the processor for selectively energizing the coil and driving the plunger, and for otherwise carrying out methods and steps as described herein. For example, the processor 60 may access a vehicle control module configured to provide directives for other vehicle systems. The processor 60 may include one or multiple processors or electronic controllers, capable of performing instructions and executing algorithms, as is known in the art. The memory 62 may be any type of volatile or non-volative memory, as is known in the art.

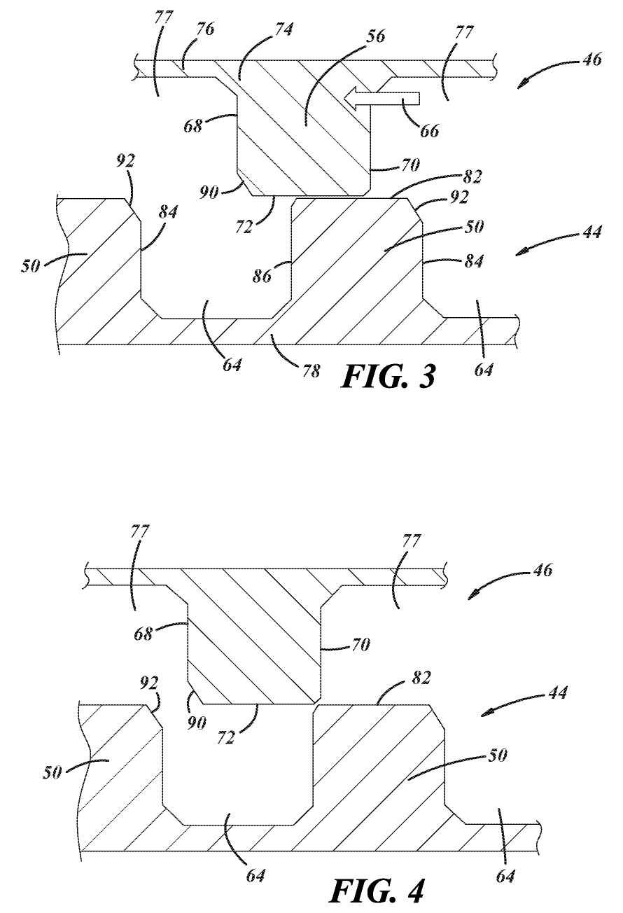

During actuation of the clutch 30 and prior to engagement of the clutch 30, the second clutch member 46 may rotate relative to the first clutch member 44, and, as shown in FIGS. 3 and 4, the teeth 56 of the second clutch member 46 may be misaligned relative to pockets between adjacent teeth 50 of the first clutch member 44. In this state, the second clutch member 46 cannot move axially to the advanced position and the teeth 50, 56 of the clutch members 44, 46 are not meshed. In use, there is relative rotation between the clutch members 44, 46 which enables the teeth 56 of the second clutch member 46 to become aligned with open spaces (e.g. pockets 64) defined between adjacent teeth 50 of the first clutch member 44.

In more detail, in the example shown in FIGS. 3-7, the second clutch member 46 rotates relative to (e.g. rotates at a different rate/speed) the first clutch member 44 in a first direction, shown as left in the drawings as indicated by the arrow 66. In this direction, each tooth 56 of the second clutch member 46 has a first or leading face 68 and a second or trailing face 70, on opposite sides of a tip 72 which defines a free, axial end of the tooth 56 and is opposite to a base 74 that is connected to a main body 76 of the second clutch member 46. The second clutch member teeth 56 are circumferentially spaced apart providing open spaces or pockets 77 between adjacent teeth 56. The first clutch member 44 likewise has a main body 78, and the teeth 50 of the first clutch member 44 have a base 80 connected to the main body 78, an opposite tip 82 defining a free, axial end, a first face 84 and a second face 86 on the opposite side as the first face.

As shown in FIG. 7, when the clutch members 44, 46 are engaged, and the teeth 50, 56 are meshed, torque can be transmitted through the clutch members 44, 46. In this position, the trailing face 70 of each tooth 56 of the second clutch member 46 is in contact with the second face 86 of an adjacent tooth 50 of the first clutch member 44. A gap 88 exists between the leading face 68 of each tooth 56 of the second clutch member 46 and the first face 84 of an adjacent tooth 50 of the first clutch member 44, to ensure sufficient space to facilitate engagement and disengagement of the clutch members 44, 46.

To control the relative rotational speed at which the teeth 56 of the second clutch member 46 can become engaged with the teeth 50 of the first clutch member 44, the circumferential size of the clutch member pockets 64, 77 relative to the circumferential size of the clutch member teeth 50, 56 can be controlled. The circumferential size of the pockets 64 is the distance between the first face of one tooth and the second face of another tooth on the opposite side of a pocket 64, 77. The circumferential size of the teeth 50, 56 is the distance between the leading and trailing faces of the teeth 50, 56. A larger circumferential size of the pockets 64, 77 (larger gap between meshed teeth) can facilitate engagement of the clutch members 44, 46 and will lead to increased relative motion or backlash, when the teeth 50, 56 are initially meshing. A smaller circumferential size of the pockets 64, 77 (smaller gap between meshed teeth) provides less backlash but requires a lower relative rotational speed to achieve engagement.

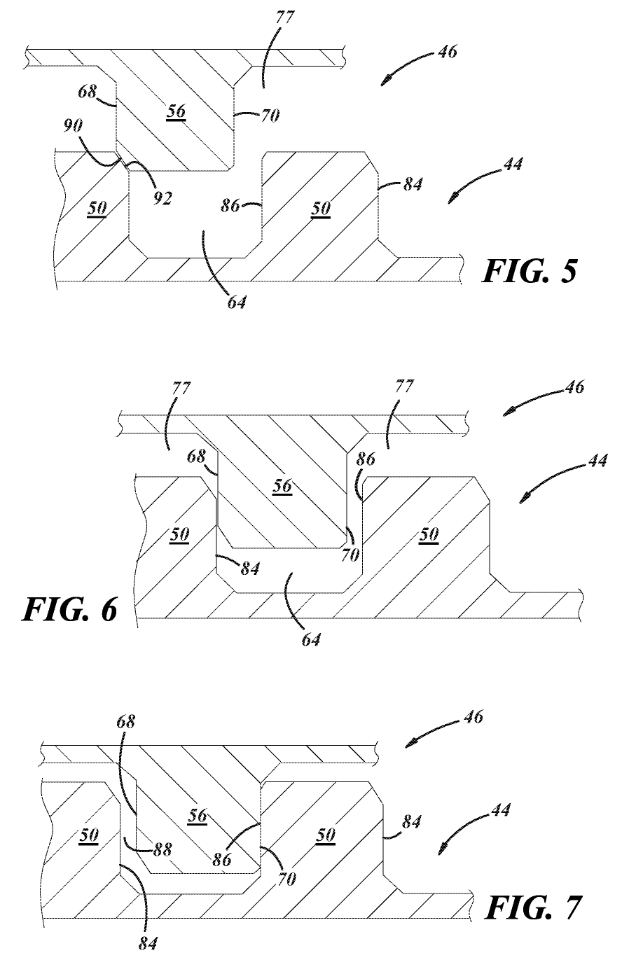

In FIG. 4, the second clutch member 46 is prevented from moving axially by the teeth 56 of the second clutch member 46 which are overlapped with part of the tip 82 of the first clutch member teeth 50. Upon further rotation of the second clutch member 46, as shown in FIG. 5, the trailing face 70 of the second clutch member teeth 56 pass the second face 86 of the first clutch member teeth 50 and the second clutch member 46 is able to move axially toward the first clutch member 44. However, in this example, the relative rotational speed is greater than a meshing threshold speed and so the leading face 68 of the second clutch member teeth 56 engage the first face 84 of the first clutch member teeth 50 before the second clutch member 46 has moved sufficiently axially to cause meshing of the teeth 50, 56. In this example, both the leading face 68 of the second clutch member teeth 56 and the first face 84 of the first clutch member teeth 50 include an inclined or chamfered surface 90, 92, respectively, extending from the tip 72, 82 of each tooth 50, 56 and a first distance axially toward the base 74, 80. Each inclined or chamfered surface reduces the size of a tooth on which the surface is provided, and increases the size of a corresponding pocket between adjacent teeth, which can enable a desired engagement of the teeth of the clutch members. The inclined/chamfered surfaces 90, 92 can reduce the force of impact between the teeth 50, 56 when the relative rotational speed is greater than the threshold, as compared to what the force of impact would be if the teeth did not have the chamfered surfaces. And the chamfered surfaces 90, 92 also tend to axially displace the second clutch member 46 away from the first clutch member 44, against the force acting axially on the second clutch member 46 (the force from the powered actuator 32 or a spring, for example). In this way, the teeth 56 of the second clutch member 46 may skip off and pass the teeth 50 of the first clutch member 44, until the relative rotational speed satisfies the threshold speed.

One or both of the trailing face 70 of the second clutch member teeth 56 and the second face 86 of the first clutch member teeth 50 do not have a chamfered surface like the opposite sides of the teeth 50, 56, but might have a smaller rounded portion or smaller chamfer so that the edges of the teeth faces are not defined by a sharp line (e.g. not a straight edge between the faces and the tip of the teeth). In at least some implementations, the trailing face 70 and second face 86 have a chamfer or roundness extending axially between 0.2mm and 0.5mm with teeth having a total axial length of between 2mm and 3mm. In at least some implementations, the chamfered surfaces 90, 92 have an axial dimension that is 0.3mm or greater than the axial dimension of a rounded or chamfered feature at the opposite tooth faces 70, 86, and the chamfered surfaces 90, 92 may be between 0.5mm to 1.0mm in axial length in examples with total axial dimension of the tooth faces (shown by L in FIG. 3) between 2mm and 3mm. Further, the teeth 50, 56 may be oriented axially, that is, perpendicular to the body 76, 78 of each clutch member 44, 46, or at an angle thereto, for example, up to a five-degree angle of inclination relative to the axis 24. And the teeth 50, 56 may be radially oriented, or they may be inclined relative to the radial direction.

Without a larger inclined/chamfered surface at these faces of the teeth 50, 56, the second clutch member 46 remains axially farther away from the first clutch member 44 until the trailing faces 70 of the second clutch member teeth 56 fully clear the second faces 86 of the first clutch member teeth 50, as can be seen in FIG. 4. If a chamfer or inclined surface were provided at these faces as well, then the second clutch member 46 would begin to move axially as the chamfers become aligned and this would facilitate meshing of the teeth 50, 56 as the second clutch member 46 would need to move a lesser, further distance axially to the fully meshed position. Accordingly, the lack of a chamfered surface at the trailing edge 70 of the second clutch member teeth 56 requires a slower relative rotational speed to achieve engagement of the clutch 30.

As shown in FIG. 6, when the relative rotational speed between the clutch members 44, 46 satisfies the threshold, then the force moving the second clutch member 46 axially is able to move the second clutch member so that the teeth 56 thereof are received into the pockets 64 of the first clutch member 44 sufficiently to mesh the clutch members 44, 46. When meshed, as shown in FIG. 7, the second face 86 of the first clutch member teeth 50 is in contact with (e.g. is engaged with) the trailing face 70 of the second clutch member teeth 56 and torque is transmitted through the clutch 30. Without chamfers on the trailing face 70 of the second clutch member 46 and the second face 86 of the first clutch member 44, an axially longer overlap and greater area of contact is enabled between the teeth 50, 56 of the clutch members 44, 46, as compared to a clutch in which chamfers are provided on these faces. This enables greater torque transmission (and the ability to handle lower torque with less stress on the teeth of the clutch members 44, 46).

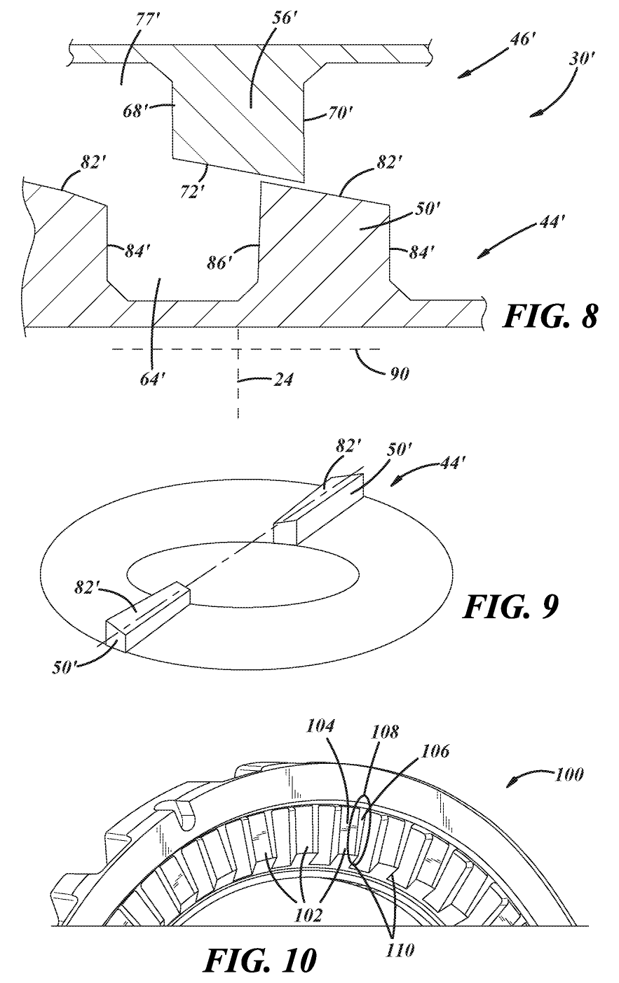

With the chamfer surfaces 90, 92 provided on the leading face 68 of the second clutch member teeth 56 and the first face 84 of the first clutch member teeth 50, engagement of the clutch 30 (i.e. meshing of the teeth) occurs more readily when the relative rotation between the clutch members 44, 46 is in the opposite, second direction (to the right in FIGS. 7-8). This may occur, for example, in reverse driving of the vehicle, and the vehicle speed is generally lower and the torque needed to be transmitted through the clutch 30 is lower. So the shorter axial length of the faces 68, 84 of the teeth 50, 56 engaged in this situation is not problematic. Additionally, in the example of a vehicle having an electric traction motor that provides propulsive torque (e.g. an electric or hybrid vehicle), driving the traction motor faster to provide relative rotation in the second direction can facilitate engagement of the clutch 30, at higher rotational speeds for faster engagement of the clutch 30, if desired. In this way, the speed at which the clutch 30 can be engaged is different and lower in the first direction than in the second direction. In the drawings, the chamfer surfaces are shown as a forty-five degree angled surface, but other angles may be used. The angle and the depth of the larger chamfer surfaces 90 and 92 can be tuned so that the engagement limit speed can be altered to meet a desired engagement speed range.

In the example of FIG. 8, the clutch 30’ has clutch members 44’, 46’ that have teeth 50’, 56’ with inclined tips 72’, 82’ (e.g. tips that are not perpendicular to the faces of the teeth, and that are inclined relative to a plane 94 that is perpendicular to the rotational axis 24 and to the direction of axial motion of the second clutch member 46). The first clutch member 44’ includes teeth 50’ that each have a second face 86’ that is axially longer than the opposite first face 84’, and the second clutch member 46’ has teeth 56’ that each have a trailing face 70’ that is axially longer than the leading face 68’. In this way, when the trailing face 70’of the second clutch member teeth 56’ are nearing alignment with the second face 86’ of an associated tooth 50’ of the first clutch member 44’, the second clutch member 46’ is axially farthest from the advanced or engaged position. Additionally, the leading face 68’ of each tooth 56’ is raised higher relative to the first face 84’ of an adjacent tooth 50’ of the first clutch member 44 which makes it more likely that the leading face 68’ will not engage and will pass by the first face 84’ of a next tooth 50’ of the first clutch member 44’ if the relative rotational speed does not meet the threshold speed. In this way, a lower relative rotational speed is needed in order for the teeth 56’ of the second clutch member 46’ to be received within pockets 64’ of, and become meshed with, the first clutch member teeth 50’.

FIG. 9 shows a generally diametrically opposed pair of teeth 50’ that are in an annular array of teeth 50’ on the first clutch member 44’, and the teeth 50’ have inclined tips 82’ as shown in the example of FIG. 8. The diametrically opposed teeth 50’ provide oppositely inclined tips 82’ and this provides a centering action or effect on the second clutch member 46’. This self-aligning effect is not realized with conventional dog clutch teeth that have flat, perpendicular tips, as shown in the example of FIG. 3. The clutch members 44’, and 46’ may otherwise function as noted with regard to the clutch 30 herein.

The clutch 30 can be provided with clutch members 44, 46 having teeth with faces having different axial lengths that enable meshing at a first threshold speed in one direction of relative rotation between the clutch members 44, 46 and at a second threshold speed in the other direction of relative rotation, where the threshold speeds are not the same. This can require a lower relative speed for the engagement to occur in one direction to make engagement more difficult in one direction than the other. In the example of a vehicle with a traction motor, the traction motor speed in relation to the vehicle speed can be controlled to enable engagement of the clutch 30 in either direction, and particularly, in at least some implementations, a greater engagement speed can be enabled in a direction that is associated with lower torque transfer between the clutch members 44, 46 and a lower engagement speed in the opposite direction, having higher torque transfer requirements. While noted as being particularly effective with a vehicle having an electric traction motor or the like, the clutch 30 can be used with vehicles having internal combustion engines as well, understanding that achieving speed differences between the propulsion source and the vehicle speed is more difficult.

As noted, engagement of a clutch 30 like a dog clutch, starts when a force on the axially moving clutch member is great enough to cause axial movement of that clutch member. In the examples above, the moving clutch member was referred to as the second clutch member 46, and the moving clutch member is driven in one direction by an actuator 32, which may be electrically powered, and in the other direction by a spring 42 (when the spring force is greater than the actuator force). In at least some implementations, the moving clutch member is spring biased to the engaged position. When movement in the engaging direction is fast enough, relative to the rotation of the clutch members 44, 46, the teeth 56 of the moving clutch member 46 move into pockets 64 of the nonmoving clutch member 44. When contact is made between teeth 50, 56 of the clutch members 44, 46 sufficiently deep within the pockets 64, 77, then the clutch members 44, 46 can become engaged and the teeth can mesh. If the contact between teeth 50, 56 of the clutch members 44, 46 occurs within a chamfered or inclined portion of a tooth face, then the moving clutch member 46 is directed away from engagement and the moving clutch member “ratchets” or continues to relatively rotate to the nonmoving clutch member 44, over the tips 82 of the teeth 50 of the nonmoving clutch member 44, until the moving clutch member teeth 56 become aligned with the next pockets 64 of the nonmoving clutch member 44 and engagement is again attempted under the force acting axially on the moving clutch member 46.

In some applications, the dog clutch 30 is expected to engage at higher delta rotational speed without ratcheting. However, in some applications, lower engagement speed is desired, to, for example, avoid strong impact on the drivetrain that is generated by clutch engagement at high delta rotational speed. Because fast clutch engagement is desirable in at least some driving situations, it might not be desirable to reduce the force driving the moving clutch 30 to the engaged position, to slow down the axial movement of the moving clutch member. Thus, the clutch 30 tends to become engaged at higher delta rotational speeds due to the higher axial engagement force used. Further, reducing the space between teeth (e.g. making the circumferential size of the pockets 64, 77 closer to the circumferential size of the teeth 50, 56) can also decrease the delta rotational speed at which engagement occurs. However, due to one or more factors for example, production tolerances and possible misalignment of the clutch members 44, 46, the pockets 64, 77 need to be at least somewhat larger than the teeth 50, 56, so this limits the ability to control engagement at a certain delta rotational speed.

Further, in an electric vehicle, a loss of electrical power or a failure in the electric motor can result in the traction motor speed decreasing relative to the vehicle/wheel speed. Further, a loss of electrical power to, or other failure of, the clutch actuator 32 can result in loss of force from the clutch actuator 32 to disengage the clutch 30 or maintain the clutch 30 in the disengaged state. The traction motor speed decrease can cause a higher delta rotational speed as the wheel speed that is transferred to the nonmoving clutch member 44 is greater than the rotational speed of the second clutch member 46 which is driven by the traction motor. In this case, engagement of the clutch 30 does not occur until such time as the wheel speed decreases sufficiently to provide a delta rotational speed that satisfied the threshold speed for engagement. This can protect against too great of impact forces that might result if clutch engagement occurred at higher delta rotational speeds. In this situation, the clutch 30 will “ratchet”, with teeth passing over each other, until such time as the delta rotational speed decreases sufficiently to permit engagement. In other situations (e.g. when the traction motor is powered and functioning properly), the speed of the traction motor can be changed so that the rotational speed of the moving clutch member more closely matches that of the nonmoving clutch member, to enable smooth and rapid clutch engagement with limited or not ratcheting occurring.

Preventing engagement at higher delta rotational speeds as noted works in the forward driving direction, but not in the reverse driving direction in which clutch engagement can occur at higher delta rotational speed due to the chamfered surfaces provided on one side of the teeth, as noted. In at least some implementations, the controller 60 can be programmed to always engage the clutch 30 whenever a shift lever or other drive mode shifter is in a position to permit reverse vehicle operation. Thus, if electrical power loss occurs when the vehicle is being driven in reverse, the clutch 30 will already be engaged. In vehicle operation, a shifter may be used to select one or more forward or reverse operating modes of the vehicle, as is known. The shifter may be controlled by a person driving the vehicle, or by a control system in an autonomous or partly autonomous vehicle, as is also known. Further, the controller 60 may define or be part of a control system, and the controller/control system can manage other vehicle functions, including operation of the traction motor 96, as diagrammatically shown in FIG. 1.

In the implementation shown in FIG. 10, a clutch member 100 can have teeth 102 that have a inclined or slanted axial end, or tip 104, and an axial stopper 106, as shown in the encircled portion 108 of FIG. 10. This may be useful to, for example, provide an accurate axial stopper function. The inclined tip 104 and stopper 106 form a reduced axial dimension of the associated tooth faces 110, and the clutch members 100 formed this way may function generally as described herein.

It is to be understood that the above description is intended to be illustrative and not restrictive. Many embodiments and applications other than the examples provided would be apparent to those of skill in the art upon reading the above description. The scope of the invention should be determined, not with reference to the above description, but instead with reference to the appended claims, along with the full scope of equivalents to which such claims are entitled. It is anticipated and intended that future developments will occur in the arts discussed herein, and that the disclosed assemblies and methods will be incorporated into such future embodiments. In sum, it should be understood that the invention is capable of modification and variation that is limited only by the following claims.

All terms used in the claims are intended to be given their broadest reasonable constructions and their ordinary meanings as understood by those skilled in the art unless an explicit indication to the contrary in made herein. In particular, use of the singular articles such as "a," "the," "said," etc. should be read to recite one or more of the indicated elements unless a claim recites an explicit limitation to the contrary. In the preceding description, various operating parameters and components are described for one or more exemplary embodiments. These specific parameters and components are included as examples and are not meant to be limiting.

Reference in the preceding description to "one example," "an example," "one embodiment," "an embodiment", "an implementation" or "at least some implementations" means that a particular feature, structure, or characteristic described in connection with the example is included in at least one example or implementation including one or more but not necessarily all innovative features or components. References to various examples, embodiments or implementations do not necessarily refer to the same example, embodiment or implementation each time it appears.

1. A dog clutch, comprising:
a first clutch member having a first body rotatable about an axis of rotation and first teeth extending axially from the first body, the first teeth are circumferentially spaced apart with first pockets defined between adjacent ones of the first teeth, each tooth of the first teeth having a first face and a second face, and an axial length of the first face is different than the axial length of the second face; and
a second clutch member having a second body rotatable about the axis of rotation and movable axially relative to the first clutch member, the second clutch member has second teeth extending axially from the second body, the second teeth are circumferentially spaced apart with second pockets defined between adjacent ones of the second teeth, each tooth of the second teeth having a first face and a second face, and an axial length of the first face is different than the axial length of the second face, and wherein an axially longer face of the first teeth is adjacent to an axially longer face of the second teeth when the first clutch member and the second clutch member are in an engaged state in which the first teeth are received in the second pockets, and the second teeth are received in the first pockets.

2. The clutch of claim 1 wherein each tooth of the first teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body.

3. The clutch of claim 2 wherein the axial dimension of the inclined surface is between 15% and 30% of the length of the tooth from the tip to the body.

4. The clutch of claim 2 wherein the axial length of the second face is greater than the axial length of the first face not including the axial dimension of the inclined surface.

5. The clutch of claim 2 wherein the axial length of the first face not including the axial dimension of the inclined surface is at least 0.3mm less than the axial length of the second face.

6. The clutch of claim 2 wherein the second face has a rounded or chamfered surface leading to the tip, and the axial length of the first face not including the axial dimension of the inclined surface is at least 0.3mm less than the axial length of the second face not including the axial dimension of the rounded or chamfered surface of the second face.

7. The clutch of claim 1 wherein each tooth of the second teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body.

8. The clutch of claim 7 wherein the axial dimension of the inclined surface is between 15% and 30% of the length of the tooth from the tip to the body.

9. The clutch of claim 7 wherein the axial length of the second face is greater than the axial length of the first face not including the axial dimension of the inclined surface.

10. The clutch of claim 7 wherein the second face has a rounded or chamfered surface leading to the tip, and the axial length of the first face not including the axial dimension of the inclined surface is at least 0.3mm less than the axial length of the second face not including the axial dimension of the rounded or chamfered surface of the second face.

11. A differential, comprising:
a first housing arranged to be rotated by a vehicle motive power source;
a second housing;
differential gears coupled to the second housing, the differential gears including at least one pinion gear, a first side gear engaged with the pinion gear, and a second side gear engaged with the pinion gear;
a clutch, the clutch has a first clutch member that is coupled to the second housing and a second clutch member that is coupled to the first housing, the clutch has a disengaged state in which the first housing rotates relative to the second housing, and the clutch has an engaged state in which the second housing is coupled to and rotates with the first housing, wherein:
the first clutch member has a first body rotatable about an axis of rotation and first teeth extending axially from the first body, the first teeth are circumferentially spaced apart with first pockets defined between adjacent ones of the first teeth, each tooth of the first teeth having a first face and a second face, and an axial length of the first face is different than the axial length of the second face; and
the second clutch member has a second body rotatable about the axis of rotation and movable axially relative to the first clutch member, the second clutch member has second teeth extending axially from the second body, the second teeth are circumferentially spaced apart with second pockets defined between adjacent ones of the second teeth, each tooth of the second teeth having a first face and a second face, and an axial length of the first face is different than the axial length of the second face, and wherein an axially longer face of the first teeth is adjacent to an axially longer face of the second teeth when the first clutch member and the second clutch member are in an engaged state in which the first teeth are received in the second pockets, and the second teeth are received in the first pockets.

12. The differential of claim 11 wherein each tooth of the first teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body.

13. The differential of claim 11 wherein each tooth of the second teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body.

14. The differential of claim 11 wherein each tooth of the first teeth has a tip that defines an axial end of the tooth, and the tip extends between the first face and the second face, and each tooth includes an inclined surface extending from the tip to the first face, the inclined surface is not parallel to tip or to the first face, and the axial length of the first face to the inclined surface is less than the length from the tip to the body, and wherein each tooth of the second teeth has a tip that defines an axial end of each tooth of the second teeth, and the tip of each tooth of the second teeth extends between the first face and the second face of each tooth of the second teeth, and each tooth of the second teeth includes an inclined surface extending from the tip to the first face, the inclined surface is not parallel to tip or to the first face of each tooth of the second teeth, and the axial length of the first face to the inclined surface of each tooth of the second teeth is less than the length from the tip to the body of each tooth of the second teeth.

15. The differential of claim 11 wherein an axially shorter face of the first teeth is a leading face when a vehicle including the differential is traveling in a reverse direction.

16. The differential of claim 12 wherein the first face of each of the first teeth is a leading face when a vehicle including the differential is traveling in a reverse direction.
